(19) United States
(12) Patent Application Publication
(10) Pub. No.: US 2013/0088342 A1
(43) Pub. Date: Apr. 11, 2013

(54) METHOD OF GENERATING HAPTIC EFFECT USING VARIATION IN SOUND VOLUME

(71) Applicant: IMAGIS TECHNOLOGY CO., LTD., Suwon-si (KR)

(72) Inventors: Ho Pil AHN, Suwon-si (KR); Han Eol BAE, Suwon-si (KR); Yong Jin CHO, Suwon-si (KR); Sung Uk PARK, Suwon-si (KR)

(73) Assignee: IMAGIS TECHNOLOGY CO., LTD., Suwon-si (KR)

(21) Appl. No.: 13/645,999

(22) Filed: Oct. 5, 2012

(30) Foreign Application Priority Data
Oct. 5, 2011 (KR) 10-2011-0101520

(51) Int. Cl. G08B 6/00

(52) U.S. Cl. 340/407.1

(57) ABSTRACT

A method of generating a haptic effect using a variation in sound volume is provided. According to the method, when an electronic device having the haptic device provides a sound effect, by dividing the variation types of a sound volume stored as generated sound source data, and generating the haptic effects depending on the variation types, the haptic feedback can be provided together with the audio feedback to the user. Furthermore, by dividing the variation types of sound volume before and after output with respect to sound output which consecutively changes, and generating the haptic effects depending on the variation types, various haptic feedbacks can be provided together in line with the audio feedback provided to the user.

### PRIORITY

This application claims the benefit under 35 U.S.C. §119(a) of a Korean patent application filed on Oct. 5, 2011 in the Korean Intellectual Property Office and assigned Serial No. 10-2011-0101520, the entire disclosure of which is hereby incorporated by reference.

### BACKGROUND OF THE INVENTION

1. Field of the Invention

The present invention relates, in general, to a method of generating a haptic effect. More particularly, the present invention relates to a method of generating a haptic effect using a variation in sound volume.

2. Description of the Related Art

Generally, as information and communication terminals such as a notebook computer, a smartphone, a tablet PC and the like, or electronic devices such as a video game console, remote control and the like have been developed, researches have been recently actively carried out to provide more various User Experiences (UX) to the users using these devices. For example, the existing user terminal shows a two-dimensional plane screen and provides only a simple level of audiovisual feedback for giving sounds in line with content shown on a screen. However, recent user terminals can provide a screen having a three-dimensional cubic effect and can also provide more complex visual feedback, haptic feedback and the like which enable the user to feel a force, a sense of movement, a texture and the like together with a content of the provided screen.

In this way, a purpose of providing various feedbacks to the users from all kinds of electronic devices is to give a greater sense of reality to experiences in which one can look, hear, and feel through the terminal. In general, when various sensuous feedback provided from the terminal are combined together, the user has an experience having a greater sense of reality. For this reason, conventional arts for providing the visual feedback and the haptic feedback at the same time have been mainly developed. For example, these arts have been applied to a video game console, to which a vibration effect is provided, or a synthetic flight training facility for training pilots. However, in addition to the combination of the visual and haptic feedback, many researches on technologies for providing audio feedback and the haptic feedback together have been recently carried out.

In the user terminal for providing the audio feedback, all sounds generated from the terminal go through a process in which they are first stored as digital signals in a Pulse Code Modulation (PCM) type, and thereafter are converted into analog signals through a Digital Analog Converter (DAC) to be output to the outside. At this time, regenerated sound source data are digital signals composed of combinations of ‘1’ and ‘0’, and contain information on the amplitude of sounds which are intended to be output. Accordingly, if a haptic device provided in the terminal can be controlled together in line with the sound source data which will be provided as the audio feedback, the audio feedback and the haptic feedback can be provided to the user at the same time.

However, the provision of the audio and haptic feedback by the conventional arts only generates haptic effects of a pre-defined type when music is regenerated with respect to mostly pre-stored sound sources. Thus, in consideration of all events which may be generally generated as well as music, the conventional arts have a limit in providing the haptic feedback. Also, it is problematic that it takes a lot of time to pre-define haptic effects which may be generated in consideration of all events related to the audio feedback. Furthermore, in the case of a technology for providing sound data in addition to music files as the haptic feedback, it is also problematic that it is not concretely disclosed by what type the haptic feedback is provided according to a variation in sound volume, namely, a method of embodying it is not disclosed.

### SUMMARY OF THE INVENTION

Aspects of the present invention are to address at least the above-mentioned problems and/or disadvantages and to provide at least the advantages described below. Accordingly, an aspect of the present is to provide a method of generating a haptic effect using a variation in sound volume, which can provide haptic feedback together in line with audio feedback provided to the user by dividing variation types of sound volume stored as generated sound source data, and generating a haptic effect depending on the variation types when an electronic device having a haptic device provides a sound effect.

Another aspect of the present invention is to provide a method of generating a haptic effect using a variation in sound volume, which can provide various haptic feedback together in line with audio feedback provided to the user by dividing variation types of sound volume before and after output with respect to sound output which consecutively changes, and generating a haptic effect depending on the variation types.

In accordance with one aspect of the present invention, a method of controlling a haptic device using a variation amount of a sound volume is provided. The method includes extracting two or more representative values with respect to sound source data, measuring a variation amount depending on time with respect to the extracted representative values, determining a variation type of the representative values depending on the measured variation amount, and generating different haptic effects from each other depending on the determined variation types.

Preferably, the method may further include in step (0-1) sampling sound source data from an electronic device having a sound signal output unit, wherein the sound source data sampled in step (0-1) may be a digital signal extracted from an analogue signal or a pulse width modulation signal of the sound source data output unit.

More preferably, the sound source data sampled in step (0-1) may be a digital source data signal which will be output from the sound signal output unit.

Preferably, the extracting in step (1) may be accomplished by a downsampling method using a low pass filter.

Preferably, the method may further include step (0-2) setting the number of representative values which will be extracted from the sound source data as two or more numbers, wherein in step (1), the representative values may be extracted from the sound source data depending on the set number in step (0-2).

More preferably, the extracting in step (1) may be accomplished by classifying the sound source data into groups based on the set number in step (0-2) and calculating representative values to the classified groups.

Preferably, in step (1), two representative values with respect to the sound source data may be extracted, wherein the variation type of the representative values determined in step (3) may include at least one of no change, increase, and decrease.

Preferably, in step (1), three representative values with respect to the sound source data may be extracted, wherein the variation type of the representative values determined in step (3) may include at least one of no continuous change, continuous increase, continuous decrease, decrease after increase, and increase after decrease.

Preferably, the haptic effect in step (4) may include at least one of: no effect, a haptic effect corresponding to any one of the representative values, a haptic effect corresponding to any one of the representative values, and sudden stop control of an effect which is performed immediately thereafter, sudden stop control of an effect, and a haptic effect corresponding to any of the representative values which is performed immediately thereafter, a haptic effect corresponding to a multiple of any one of the representative values, and a haptic effect corresponding to an average of any two of the representative values.

Furthermore, in order to achieve the above object, according to another aspect of the present invention, a method of generating a haptic effect using a variation in sound volume is provided, the method includes: extracting at least two or more first representative values with respect to a first sound source data which is sampled from an electronic device which will output a sound signal, measuring a first variation amount depending on time with respect to the extracted first representative values, determining a variation type of the first representative values depending on the measured first variation amount, extracting at least two or more second representative values with respect to a second sound source data following the first sound source data, measuring a second variation amount depending on time with respect to the extracted second representative values; determining a variation type of the second representative values depending on the measured second amount of variation, and generating different haptic effects from each other depending on the determined variation type of the second representative values which follows the determined variation type of the first representative values.

Preferably, in step (1), two first representative values with respect to the first sound source data may be extracted, and in step (4), two second representative values with respect to the second sound source data may be extracted. Furthermore, the variation types of the first representative values and the second representative values determined in steps (3) and (6) may include at least one of no change, increase, and decrease, respectively.

Preferably, in step (1), three first representative values with respect to the first sound source data may be extracted, and in step (4), three second representative values with respect to the second sound source data may be extracted.

Furthermore, the variation types of the first representative values and the second representative values determined in steps (3) and (6) may include at least one of no continuous change, continuous increase, continuous decrease, decrease after increase, and increase after decrease.

Preferably, the haptic effect in step (7) may include at least one of: no effect, a haptic effect corresponding to any one of the first or the second representative values, a haptic effect corresponding to any one of the first or the second representative values, and sudden stop control of an effect which is performed immediately thereafter, sudden stop control of an effect, and a haptic effect corresponding to any one of the first or the second representative values which is performed immediately thereafter, a haptic effect corresponding to a multiple of any one of the first or second representative values, and a haptic effects corresponding to an average of any two of the first or second representative values.

According to the method of generating the haptic effect using the variation in sound volume which has been suggested by the present invention, when an electronic device having the haptic device provides a sound effect, by dividing variation types of a sound volume stored as generated sound source data and generating the haptic effects depending on the variation types, the haptic feedback can be provided together in line with the audio feedback provided to the user.

Furthermore, according to the present invention, various haptic feedbacks can be provided in line with the audio feedback provided to the user by dividing the variation types of sound volume before and after output with respect to sound output which consecutively changes, and generating the haptic effects depending on the variation types.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features and advantages of certain exemplary embodiments of the present invention will be more apparent from the following description taken in conjunction with the accompanying drawings, in which:

FIG. 1 is a flowchart illustrating a method of generating a haptic effect using a variation in sound volume according to an exemplary embodiment of the present invention;

FIG. 2 is a view illustrating a process in which step S300 of the method of generating a haptic effect using a variation in sound volume according to an exemplary embodiment of the present invention is carried out;

FIG. 3 is a view illustrating a process in which step S300 of a method of generating a haptic effect using a variation in sound volume according to an exemplary embodiment of the present invention is carried out;

FIG. 4 is a view illustrating variation types of representative values determined in step S500 of the method of generating a haptic effect using a variation in sound volume according to an exemplary embodiment of the present invention;

FIG. 5 is a view illustrating haptic effects generated in step S600 of the method of generating a haptic effect using a variation in sound volume according to an exemplary embodiment of the present invention; and

FIG. 6 is a flowchart illustrating the method of generating a haptic effect using a variation in sound volume according to an exemplary embodiment of the present invention.

Throughout the drawings, like reference numerals will be understood to refer to like parts, components, and structures.

### DETAILED DESCRIPTION OF THE INVENTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Reference will now be made in greater detail to preferred exemplary embodiments of the present invention, an example of which is illustrated in the accompanying drawings. Wherever possible, the same reference numerals will be used throughout the drawings and the description to refer to the same or like parts. Hereinbelow, preferred exemplary embodiments of the present invention will be described in detail with reference to the accompanying drawings. In the following description, it is to be noted that, when the functions of conventional elements and the detailed description of elements related to the present invention may make the gist of the present invention unclear, a detailed description of those elements will be omitted.

In addition, throughout the specification, when a part is connected to other part, this also includes a case in which they are indirectly connected by interposing other devices therebetween as well as a case in which they are directly connected. Also, ‘including’ an element means that other elements may be further included rather than other elements being excluded unless content to the contrary is specially described.

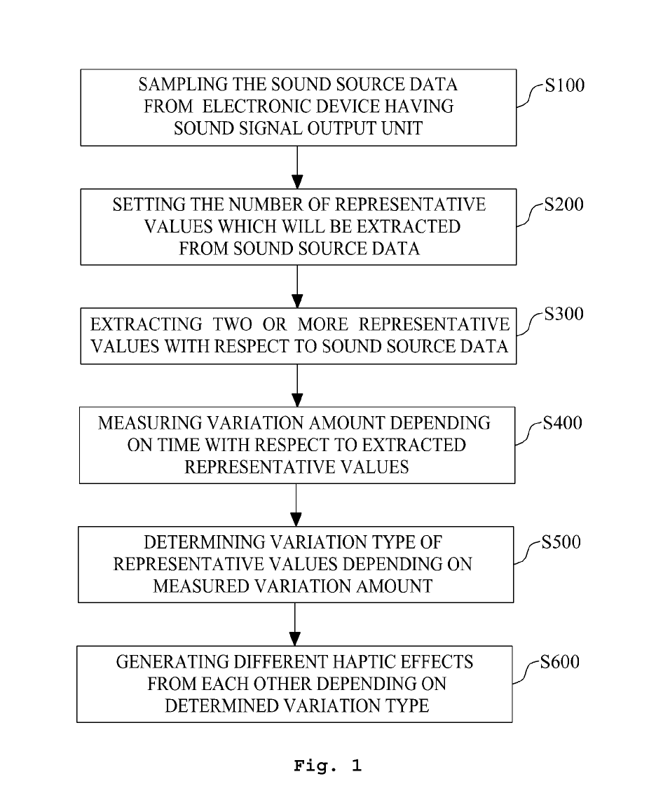

FIG. 1 is a flowchart illustrating a method of generating a haptic effect using a variation in sound volume according to an exemplary embodiment of the present invention. As illustrated in FIG. 1, the method of generating a haptic effect using a variation in sound volume according to an exemplary embodiment of the present invention may include: in step S300 extracting two or more representative values with respect to a sound source data, in step S400 measuring a variation amount depending on time with respect to the extracted representative values, in step S500 determining a variation type of the representative values depending on the measured variation amount, and in step S600 generating different haptic effects from each other depending on the determined variation type, and may further include: in step S100 sampling the sound source data from an electronic device having a sound signal output unit, and in step S200 setting the number of representative values which will be extracted from the sound source data.

The present invention may be used in all cases in which an electronic device capable of outputting a sound signal by providing a sound signal output unit further includes a vibration device which may convert electrical energy into mechanical energy in a vibration type, or a device which may generate haptic effects such as vibration, temperature change, and wind which are convertible into haptic data. Hereinafter, each step of the method of generating a haptic effect using a variation in sound volume according to an exemplary embodiment of the present invention will be explained in detail.

In step S100, sampling the sound source data from the electronic device having the sound signal output unit may be performed. At this time, the sampled sound source data may be a digital signal extracted from a pulse width modulation signal or an analogue signal of the sound signal output unit, or may be a digital source data signal which will be output from the sound signal output unit.

In step S200, the number of representative values which will be extracted from the sound source data may be set. The value which may be set as the number of representative values which will be extracted is two or more numbers. For example, it may be set so that two, three or more representative values are extracted.

In step S300, at least two or more representative values with respect to the sound source data may be extracted. At this time, when the number of representative values is pre-set in step S200, the representative values may be extracted depending on the number. The extracting of the representative values may be accomplished by a downsampling method using a low pass filter, or a method of classifying the sound source data into groups based on the number to be extracted and calculating each average according to the respective groups. Furthermore, after classifying the sound source data into the groups based on the number to be extracted and calculating each average according to the respective groups, the extracting of the representative values may also be accomplished by an extracting method using the low pass filter.

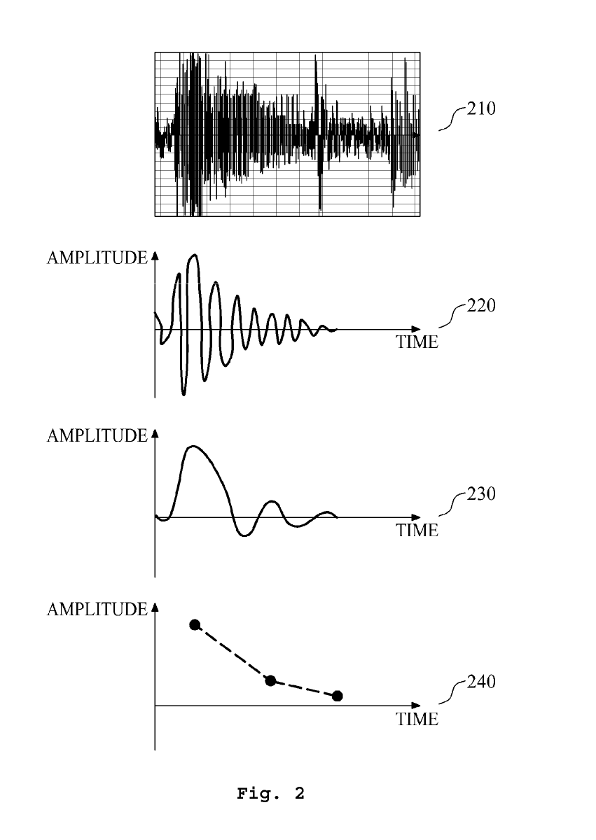

FIG. 2 illustrates a process in which step S300 of the method of generating a haptic effect using a variation in sound volume according to an exemplary embodiment of the present invention is carried out, and shows the process in which the representative values with respect to the sound source data are extracted by the downsampling method using the Low Pass Filter (LPF). As illustrated in FIG. 2, step S300 of the method of generating a haptic effect using a variation in sound volume according to an exemplary embodiment of the present invention may be accomplished, for example, by treating sound data 210 composed of time intervals of 5 ms with the low pass filter. At this time, the reason why filtering is performed by the low pass filter is because a sampling frequency (fs) used during a process of obtaining the sound source data 210 is usually set to be about two times or more higher than the maximum frequency of a sound which will be actually output. Meanwhile, when treating the sound source data with the low pass filter, different weighted values from each other are applied to each data so that the variation type of a sound signal which will be output may be more clearly exposed. Like this, the data which is primarily treated with the low pass filter shows a reduction in its number compared to the data before being treated with the filter, and only data which is less than a cut-off frequency (fc) of the low pass filter remains. Like this, the downsampling method using the low pass filter may be continuously performed until a desired final amount of data is extracted. Through FIG. 2, a process in which three data values 240 are extracted by performing three low pass filter treatments 220, 230, and 240 to the sound source data 210 can be confirmed. At this time, the three extracted data values may be determined as the representative values for the sound source data 210 before being filtered. Also, according to exemplary embodiments of the present invention, the data may be downsampled so that two representative values are finally extracted.

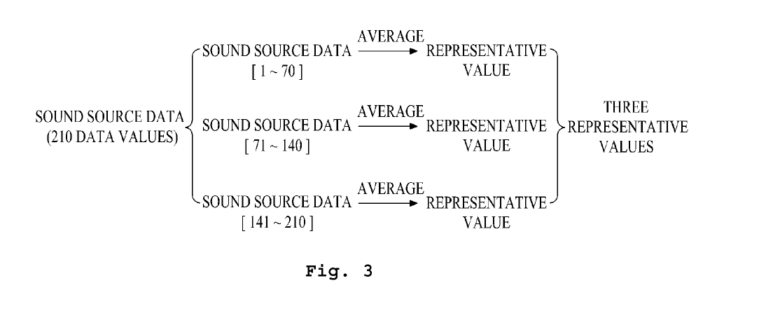

Meanwhile, the process for extracting the representative values from the sound source data may be carried out using each average according to the groups as well as the downsampling method through the filter treatment as explained above. FIG. 3 is a view illustrating a process in which step S300 of the method of generating a haptic effect using a variation in sound volume according to another exemplary embodiment of the present invention is carried out. As confirmed through FIG. 3, for example, when three representative values are extracted with respect to sound data values 210, the sound data values are classified into three groups composed of a group of from the first datum to the 70th datum, a group of from the 71st datum to the 140th datum, and a group of from the 141st datum to the 210th datum, and each average according to the respective groups is then calculated so the values may be extracted as the representative values. Also, according to the exemplary embodiments of the present invention, the representative values may be extracted by treating each average according to the respective groups as calculated above with the low pass filter again.

In step S400, a variation amount depending on time with respect to the extracted representative values may be measured. Since each representative value extracted in step S300 represents information on amplitude in a specified time section, there may be a variation amount depending on time between different representative values from each other. Accordingly, from this variation amount, the variation aspect of representative values, namely, the variation aspect of sound source data, may be differentiated. At this time, the variation amount of the representative values depending on time may be a positive integer or a negative integer. When the representative values in different time sections from each other are the same, the variation amount may be 0 (zero). Meanwhile, when three or more representative values are extracted, each representative value may have a variation amount before and after their adjacent representative values. In this case, so as to correspond to a variation aspect of the sound source data, the variation amount between the representative values may be measured in order from the front.

In step S500, the variation type of the representative values may be determined depending on the measured variation amount. At this time, the variation type of the representative values may be classified into various shapes. For example, when two representative values are extracted, the representative values may have one variation type of increase, decrease, and no change. Also, for example, when three representative values are extracted, they may have variation types as follows: a variation type in which there may be no variation amount between from the first representative value to the third representative value (a maintaining type), a variation type in which the representative value may continuously increase (a fade-in type) or may continuously decrease (a fade-out type) toward the last representative value from the first representative value, and a variation type in which, when conducting from the first representative value to the second representative value, the representative value increases, and when conducting from the second representative value to the third representative value, the representative value decreases again (a peak type). Also, they may have a variation type in which, when conducting from the first representative value to the second representative value, the representative value decreases, and when conducting from the second representative value to the third representative value, the representative value increases again (a valley type).

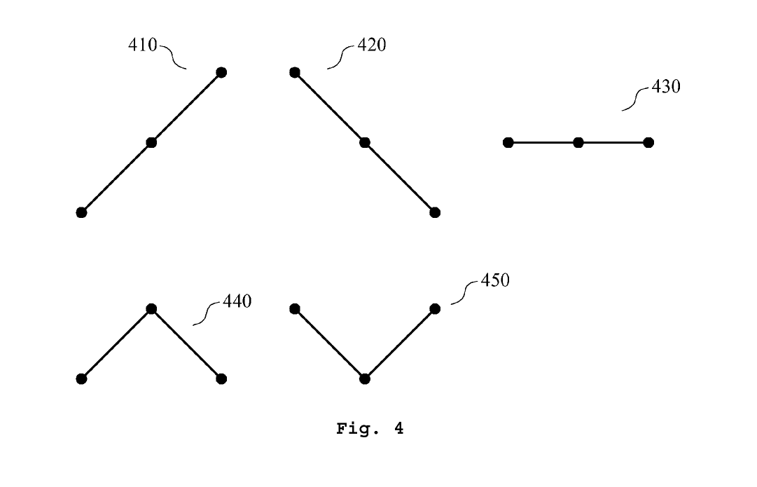

FIG. 4 shows the variation types of the representative values determined in step S500 of the method of generating a haptic effect using a variation in sound volume according to an exemplary embodiment of the present invention. As illustrated in FIG. 4, the variation types of the representative values determined in step S500 of the method of generating a haptic effect using a variation in sound volume according to an exemplary embodiment of the present invention may include any one of five types of continuous increase 410, continuous decrease 420, no continuous change 430, decrease after increase 440, and increase after decrease 450 in the case where three representative values are extracted.

In step S600, different haptic effects from each other may be generated depending on the variation type determined in step S500. That is, when the variation type of the representative values extracted from sound source data is determined, the variation type may be set in a haptic device so as to generate a haptic effect corresponding thereto. In this case, the haptic effect which can be generated by the haptic device may include: no effect, a haptic effect corresponding to any one of the representative values, a haptic effect corresponding to any one of the representative values, and sudden stop control of an effect which is performed immediately thereafter, or sudden stop control of an effect, and a haptic effect corresponding to any one of the representative values which is performed immediately thereafter, and may also include a haptic effect corresponding to a multiple of any one of the representative values or a haptic effect corresponding to an average of any two of the representative values. At this time, when the sudden stop control of an effect is performed immediately after the haptic effect corresponding to any one of the representative values is generated, a haptic pattern in which an amplitude gradually decreases may be shown. On the contrary, when a haptic effect corresponding to any one of the representative values is generated immediately after the sudden stop control of an effect is performed, a haptic pattern in which an amplitude gradually increases may be shown.

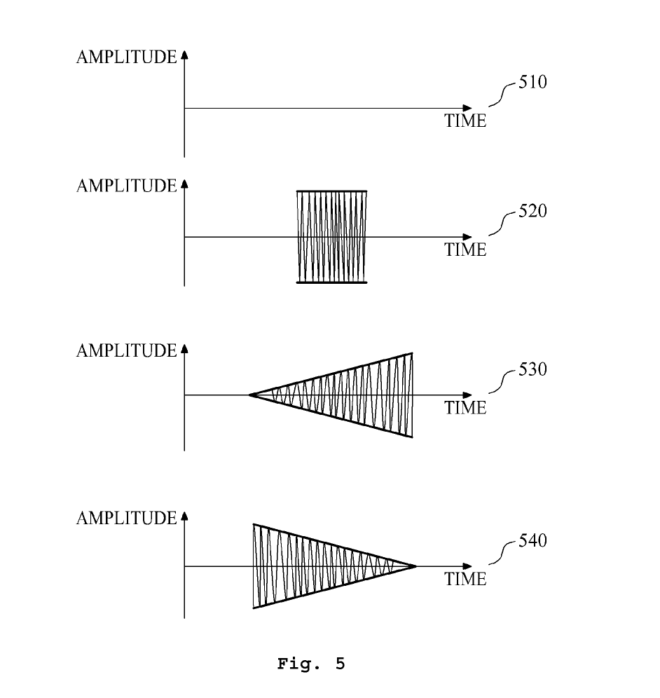

FIG. 5 shows a haptic effect generated in step S600 of the method of generating a haptic effect using a variation in sound volume according to an exemplary embodiment of the present invention. As illustrated in FIG. 5, the haptic effect generated in step S600 of the method of generating a haptic effect using a variation in sound volume according to an exemplary embodiment of the present invention may include a haptic pattern of: no effect 510, a haptic effect corresponding to any one of the representative values 520, a haptic effect in which amplitude gradually increases 530, or a haptic effect in which amplitude gradually decreases 540. For example, in the case where the haptic pattern is generated depending on the variation type of the representative values illustrated in FIG. 4, when the representative values which are not 0 are maintained without change 430, the haptic effect corresponding to the representative values may be generated, and when the representative values are maintained as 0 without change 430, the representative values may be set so that the haptic effect is not generated 510. Furthermore, when the variation type of the representative values has the type of decrease after increase 440, the sudden stop control of an effect may be carried out immediately following the generation of the haptic effect corresponding to the second representative value 540. On the other hand, when the variation type of the representative values has the type of increase after decrease 450, the haptic effect corresponding to the third representative value may be generated immediately following the sudden stop control of the effect 530.

Since the present invention includes the steps as described above, when the electronic device having the haptic device provides sound effects, by dividing the variation types of sound volumes stored in the sound source data and generating haptic effects depending on the variation types, the haptic feedback may be provided together in line with the audio feedback provided to the user.

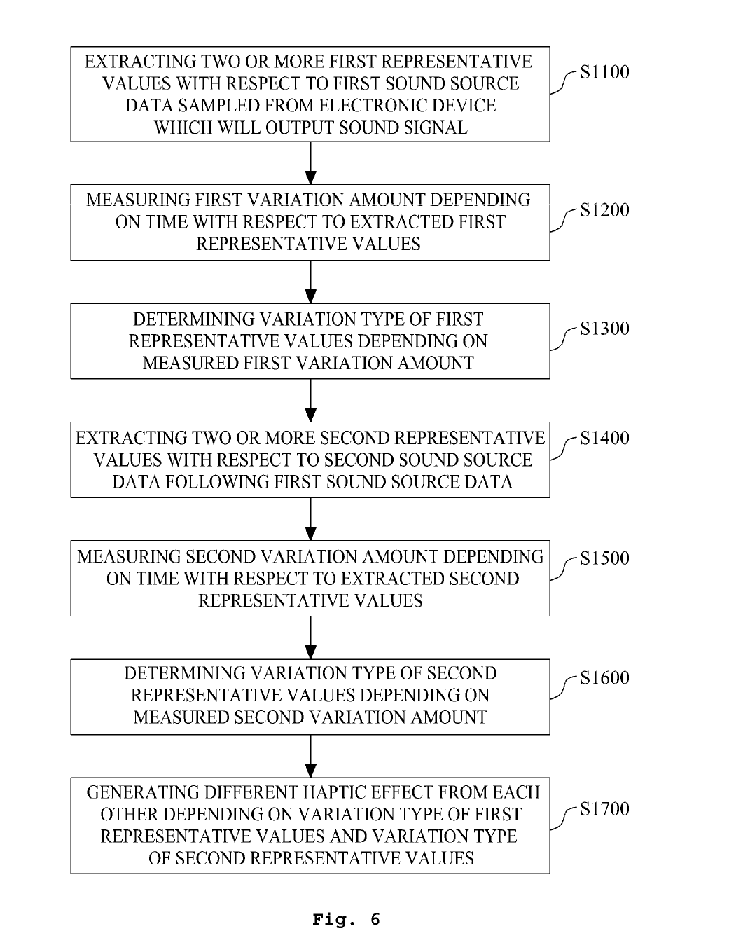

Meanwhile, the method of generating the haptic effects depending on the variation type of the representative values determined as any one type was explained above. However, when sound output is consecutively changed, it is required to divide the variation types of sound volumes before and after output and to generate the haptic effects depending on the variation types. For this, FIG. 6 illustrates a flowchart of the method of generating the haptic effects using the variation in sound volume according to still another exemplary embodiment of the present invention. As illustrated in FIG. 6, the method of generating the haptic effects using the variation in sound volume according to an embodiment of the present invention may be implemented to include: extracting two or more representative values with respect to first sound source data sampled from an electronic device which will output a sound signal in step S1100, measuring a first variation amount depending on time with respect to the extracted first representative values in step S1200, determining a variation type of the first representative values depending on the measured first variation amount in step S1300, extracting two or more second representative values with respect to second sound source data following the first sound source data in step S1400, measuring a second variation amount depending on time with respect to the extracted second representative values in step S1500, determining a variation type of the second representative values depending on the measured second variation amount in step S1600, and generating different haptic effects from each other depending on the variation type of the second representative values following the variation type of the first representative values in step S1700.

In step S1100, two or more first representative values with respect to the first sound source data sampled from the electronic device which will output the sound signal may be extracted. At this time, like step S200, the extracting of the first representative values may be accomplished by the downsampling method using the low pass filter or the method of classifying the sound source data into groups based on the number which will be extracted and calculating each average according to the respective groups. Furthermore, after classifying the sound source data into the groups based on the number which will be extracted and calculating each average according to the respective groups, it may be also accomplished by the extracting method using the low pass filter. Furthermore, the number of extracted representative values may be two, three or more numbers.

In step S1200, the first variation amount depending on time with respect to the extracted first representative values may be measured. At this time, the first variation amount depending on time with respect to the first representative values, like step S300, may be a positive integer or a negative integer. When the first representative values are the same as each other in different time sections, the variation amount thereof may be 0 (zero). Meanwhile, when three or more representative values are extracted, the variation amounts between the first representative values may be measured in order from the front.

In step S1300, the variation type of the first representative values depending on the measured first variation amounts may be determined. At this time, like step S400, the variation type of the first representative values may be classified into various shapes. For example, when two representative values are extracted, the representative values may have any one variation type of increase, decrease and no change. Also, for example, when three first representative values are extracted, the first representative values may have variation types as follows: a variation type in which there may be no variation amount between from the first representative value for the first time to the first representative value for the third time (a maintaining type), a variation in which the first representative values may continuously increase (a fade-in type) or may continuously decrease (a fade-out type) towards the first representative value for the last time from the first representative value for the first time, and a variation type in which, when conducting from the first representative value for the first time to the first representative value for the second time, the first representative value increases, and when conducting from the first representative value for the second time to the first representative value for the third time, the first representative value decreases again (a peak type). Also, they may have a variation type in which, when conducting from the first representative value for the first time to the first representative value for the second time, the first representative value decreases, and when conducting from the first representative value for the second time to the first representative value for the third time, the first representative value increases again (a valley type).

Next, in step S1400 to step S1600, with respect to the second sound source data following the first sound source data, the processes in step S1100 to step S1300 may be identically performed. That is, in step S1400, two or more second representative values with respect to the second sound source data may be extracted, in step S1500, the second variation amount depending on time with respect to the extracted second representative values may be measured, and in step S1600, the variation type of the second representative values may be determined depending on the measured second variation amount.

In step S1700, different haptic effects from each other may be generated depending on the variation type of the second representative values following the variation type of the first representative values. At this time, like step S500, the haptic effect which may be generated by the haptic device may include: no effect, a haptic effect corresponding to any one of the first or second representative values, a haptic effect corresponding to any one of the first or second representative values, and the sudden stop control of an effect which is performed immediately thereafter, or the sudden stop control of an effect, and a haptic effect corresponding to any one of the first or second representative values which is performed immediately thereafter, and may also include a haptic effect corresponding to a multiple of any one of the first or second representative values or a haptic effect corresponding an average of any two of the first or second representative values.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method of generating a haptic effect using a variation in sound volume, the method comprising:
(1) extracting two or more representative values with respect to a sound source data;
(2) measuring a variation amount depending on time with respect to the extracted representative values;
(3) determining a variation type of the representative values depending on the measured variation amount; and
(4) generating different haptic effects from each other according to the determined variation types,
wherein in step (1), the two or more representative values with respect to the sound source data are extracted, and
wherein the variation type of the representative values determined in step (3) comprise at least one of no change, increase, and decrease.

2. The method according to claim 1, further comprising:
(0-1) sampling the sound source data from an electronic device having a sound signal outputting unit, wherein
the sound source data sampled in step (0-1) is a digital signal which is extracted from a pulse width modulation signal or an analogue signal of the sound signal output unit.

3. The method according to claim 2, wherein the sound source data sampled in step (0-1) is a digital source data signal which will be output from the sound signal output unit

4. The method according to claim 1, wherein the extracting in step (1) is accomplished by a downsampling method using a low pass filter.

5. The method according to claim 1, further comprising:
(0-2) setting the number of representative values which will be extracted from the sound source data as two or more numbers, wherein
in step (1), the two or more representative values are extracted from the sound source data depending on to the set numbers in step (0-2).

6. The method according to claim 5, wherein the extracting in step (1) is accomplished by classifying the sound source data into groups based on the numbers set in step (0-2) and calculating the representative values to the classified groups.

7. The method according to claim 1, wherein the haptic effects in step (4) comprises at least one of: no effect, a haptic effect corresponding to any one of the representative values, a haptic effect corresponding to any one of the representative values, and sudden stop control of an effect which is performed immediately thereafter, sudden stop control of an effect, and a haptic effect corresponding to any one of the representative values which is performed immediately thereafter, a haptic effect corresponding to a multiple of any one of the representative values, and a haptic effect corresponding to an average of any two of the representative values.

8. A method of generating a haptic effect using a variation in sound volume, the method comprising:
(1) extracting two or more representative values with respect to a sound source data;
(2) measuring a variation amount depending on time with respect to the extracted representative values;
(3) determining a variation type of the representative values depending on the measured variation amount; and
(4) generating different haptic effects from each other depending on the determined variation type,
wherein in step (1), three representative values with respect to the sound source data are extracted, and
wherein the variation type of the representative values determined in step (3) comprises at least one type of no continuous change, continuous increase, continuous decrease, decrease after increase, and increase after decrease.

9. A method of generating a haptic effect using a variation in sound volume, the method comprising:
(1) extracting at least two or more first representative values with respect to a first sound source data sampled from an electronic device which will output a sound signal;
(2) measuring a first variation amount depending on time with respect to the extracted first representative values;
(3) determining a variation type of the first representative values depending on the measured first variation amount;
(4) extracting at least two or more second representative values with respect to a second sound source data following the first sound source data;
(5) measuring a second variation amount depending on time with respect to the extracted second representative values;
(6) determining a variation type of the second representative values depending on the measured second variation amount; and
(7) generating different haptic effects from each other depending on the determined variation type of the second representative values following the determined variation type of the first representative value.

10. The method according to claim 9, wherein in step (1), two first representative values with respect to the first sound source data are extracted, and in step (4), two second representative values with respect to the second sound source data are extracted,
wherein the variation types of the first representative values and the second representative values determined in steps (3) and (6) comprise at least one type of no change, increase, and decrease, respectively.

11. The method according to claim 9, wherein in step (1), three first representative values with respect to the first sound source data are extracted, and in step (4), three second representative values with respect to the second sound source data are extracted,
wherein the variation types of the first representative values and the second representative values determined in steps (3) and (6) comprise at least one type of no continuous change, continuous increase, continuous decrease, decrease after increase, and increase after decrease, respectively.

12. The method according to claim 9, wherein the haptic effects in step (7) comprise at least one of: no effect, a haptic effect corresponding to any one of the first or second representative values, a haptic effect corresponding to any one of the first or second representative values, and sudden stop control of an effect which is performed immediately thereafter, sudden stop control of an effect, and a haptic effect corresponding to any one of the first or second representative values which is performed immediately thereafter, a haptic effect corresponding to a multiple of any one of the first or second representative values, and a haptic effect corresponding to an average of any two of the first or second representative values.
